(19) United States
(12) Patent Application Publication
(10) Pub. No.: US 2011/0316368 A1
(43) Pub. Date: Dec. 29, 2011

(54) Electrical Machine

(75) Inventor: Gurakuq Dajaku, Neubiberg (DE)

(73) Assignee: FEAAM GmbH, Neubiberg (DE)

(21) Appl. No.: 13/127,436

(22) PCT Filed: Oct. 30, 2009
(86) PCT No.: PCT/DE2009/001556

§ 371 Date: Aug. 2, 2011

(30) Foreign Application Priority Data
Nov. 3, 2008 (DE) 10 2008 054 284.9

(51) Int. Cl. H02K 1/16; H02K 1/20

(52) U.S. Cl. 310/59; 310/216.071

(57) ABSTRACT

An electrical machine is provided, comprising a stator (7) and a rotor (8) which can be moved relative to the stator (7). The stator comprises slots (1, 2) for receiving electrical windings (+A, −A). In operation of the electrical machine, an operating wave of the magnetomotive force differs from a fundamental wave of the magnetic flux. A mechanical barrier for the fundamental wave of the magnetic flux is provided in at least one portion of the stator.

The present invention relates to an electrical machine.

Electrical machines usually comprise a housing-fixed stator as well as a rotor which can be moved relative to the stator. The rotor may be supported so as to be rotatable with respect to the stator or so as to be linearly movable relative thereto, for instance. Electrical machines are classified as electro-mechanical energy converters. In that context, they may operate as a motor or generator.

Electrical machines may be used for propelling motor vehicles, for instance. To this end as well as for other applications, it may be of advantage to achieve defined characteristics of the operational behavior of the electrical machine. The torque, the acoustic properties, the iron losses as well as the losses in the windings and in the magnets may be among these characteristics.

Stators of electrical machines with concentrated windings are distinguished by compact designs compared to those with distributed windings. Winding types such as the fractional slot winding allow different combinations of the pole pair number and the number of the slots. The number of the pole pairs in the rotor is understood to be the pole pair number, whereas the slots in the stator serve to receive the windings.

With electrical machines in motor vehicle drive systems, those with three electrical phases are most common among the multi-phase machines. Here, a three-phase machine can be connected to an electrical three-phase system with three phases which are shifted in their phase by 120° relative to each other.

Each magnetic pole pair in the rotor comprises two magnetic poles, a north pole and a south pole.

The number of the slots per pole and per phase is defined as

q=Qₛ/(2*p*m),

where m designates the number of the phases, Qₛ the number of the slots and p the number of the pole pairs in the rotor.

It is not necessarily the main wave which is applied as the operating wave in machines with concentrated windings. It may rather be of advantage to use a higher-order harmonic component of the magnetomotive force as the operating wave.

Document US 2007/0194650 A1, for instance, describes an electrical machine comprising twelve slots and ten poles. In a machine of this type, the magnetomotive force induced in operation by the stator is not distributed according to a simple sine wave. Rather, it is obvious when analyzing the magnetomotive force and its harmonic components, for instance with a Fourier decomposition, that numerous undesired harmonic components occur. Here, all harmonic components other than the one used as the operating wave of the electrical machine are undesired as these may result in losses and, in addition, may cause undesired acoustic impairments.

The term “sub-harmonic” is presently related to the operating wave.

To give an example, the fifth or seventh harmonic component may be used as the operating wave in an electrical machine comprising a stator with concentrated windings, two adjacent teeth being provided with coils of a strand (sometimes also referred to as “phase”) in the opposite winding sense. In the basic form, this results in a machine with twelve slots and ten poles or with twelve slots and 14 poles. All integer multiples of the number of the slots and of the number of the poles are also possible here.

The operating wave may also be referred to as a synchronized component. The torque of an electrical machine can be calculated from the amount of current, the distribution of the magnetomotive force and the distribution of the flux density.

In order to produce a time-independent torque, the number of the pole pairs of the rotor in the considered minimum symmetry must coincide with the harmonic order of the main wave of the magnetomotive force, based on said symmetry. The required symmetry may be given, for instance, on the quarter perimeter or the half perimeter of a rotating electrical machine.

A measure for reducing the subharmonic component is known from the cited document US 2007/0194650 A1. In this reference, however, each coil is divided into two coils and the coil systems thus obtained are shifted relative to each other. This measure, however, complicates the winding system and the machine and increases the price thereof.

It is the object of the present invention to achieve a reduction of the subharmonic component in an electrical machine at low expenditure.

According to the invention, this object is achieved by an electrical machine comprising the features of the independent claims. Embodiments and further developments are indicated in the dependent claims.

In one embodiment of the suggested principle, the electrical machine comprises a stator and a rotor which can be moved relative thereto. The stator comprises slots for receiving electrical windings. In operation, an operating wave of the magnetomotive force differs from a fundamental wave of the magnetic flux. At the same time, a mechanical barrier for this fundamental wave of the magnetic flux is provided in at least one stator portion.

The magnetic flux may be understood to be the magnetic flux in the stator and/or in the air gap between the stator and the rotor.

Here, the mechanical barrier is designed such that the fundamental wave is weakened, whereas the operating wave remains essentially unaffected or is influenced only to a small extent. The mechanical barrier impedes the formation of the fundamental wave. In this context, the fundamental wave is to be understood to be the subharmonic component with respect to the operating wave.

The significant reduction of the subharmonic component which is achieved with the suggested principle may be achieved merely by mechanical measures in the stator.

In doing so, further measures may be added in the rotor and/or in the winding; this, however, is not mandatory.

In one embodiment, the stator is designed as a stator with concentrated windings, where two adjacent teeth of the stator which each are formed between neighboring slots of the stator, are provided with coils of a strand in the opposite winding sense.

In one embodiment, a concentrated winding is assumed which is wound around a respective tooth of the stator. In this arrangement, it is not necessary that each tooth of the stator carries a winding.

In one embodiment, the at least one portion of the stator is arranged between two regions of the stator which are provided with coils of a common strand of a stator winding of the electrical machine. Different strands are assigned to different electrical phases of a multi-phase winding. Three strands may be provided in the case of a three-phase winding, for example.

In one embodiment, several mechanical barriers are provided in the stator.

It is preferred that the several mechanical barriers are regularly distributed along the circumference of the stator if a rotating machine is provided. In case of a linear motion of the rotor with respect to the stator, the mechanical barrier may be arranged equidistantly along a straight line.

For a machine with twelve slots and ten or 14 poles, for instance, six mechanical barriers may be regularly distributed along the circumference, implying one mechanical barrier at a distance of every 60°.

For integer multiples, i.e. integer multiples of twelve slots and identical integer multiples of ten or 14 poles, it is preferred that corresponding integer multiples of six mechanical barriers for the fundamental wave are provided in regular distribution on the circumference.

The mechanical barrier may be designed, for instance, in the form of a reduction of the yoke cross-section of a stator sheet metal package of the stator.

Reducing the yoke cross-section of the stator may be carried out in several ways.

The mechanical barrier may be formed, for instance, in that a slot in the stator which is present anyway in the region of the mechanical barrier is deepened with respect to the slots of the stator which are not disposed in a portion comprising a mechanical barrier. Preferably, every other slot is formed with a greater depth.

In one embodiment, the slot is formed so as to be deepened between two regions of the stator which are provided with coils of a common strand. The two external slots of this region, which is provided with coils of a strand, are not formed so as to be deepened.

In one embodiment, the deepened slots are formed in each case so as to have such a depth that an interruption of the stator arises. The stator is interrupted, for instance, between every two regions of the stator which are provided with coils of a common strand.

Alternatively or in addition, the yoke cross-section may be reduced on a side of the stator opposite the slots. In case of a rotating machine, this may take place by flattening a circular circumference. Alternatively or additionally, additional slots may be incorporated on the side of the stator facing away from the rotor.

In a further embodiment, the yoke cross-section may be reduced by incorporating holes in the yoke region.

To give an example, the mechanical barrier may be weakened by the described exemplary embodiments in the at least one portion of the stator by 50% or more compared to a design without these mechanical barriers.

The mechanical barrier may be designed such that, at the rated torque of the electrical machine, the fundamental wave in the at least one portion of the stator is weakened by at least 50% with respect to a conventional electrical machine without these additional mechanical barriers, the operating wave in this region being weakened by less than 5%.

In an alternative embodiment, the mechanical barrier may be designed such that, at the rated torque of the electrical machine, the fundamental wave in the at least one portion of the stator is weakened by at least 90% with respect to a conventional electrical machine without these additional mechanical barriers, the operating wave in this region being weakened by less than 10%.

A cooling duct may be incorporated in the additional deepening of the rotor-side slots, for instance. This allows cooling the electrical machine in operation with additional advantage.

Alternatively or in addition, it is also possible to achieve a mechanical barrier without any geometric reduction of the yoke cross-section. To this end, the yoke cross-section for the flux course may be effectively reduced in circumferential direction, for example. In doing so, flux-conducting pieces may be inserted, for instance, which have poor conductivity in the circumferential direction, but good conductivity in the axial and/or radial directions.

The mechanical barrier may comprise a sheet metal package, for instance, which exhibits a preferential direction which is different from that of a conventionally provided sheet metal package of the stator.

Alternatively or additionally, the mechanical barrier in the at least one portion of the stator may comprise a material which is different from the material of the stator outside this at least one portion. This material may comprise, for instance, sintered iron or SMC, Soft Magnetic Composites.

It goes without saying that two, three or more of the above-mentioned embodiments of the mechanical barrier may be combined with each other in an electrical machine.

A possible basic form of the winding of the suggested electrical machine comprises a concentrated winding in which two adjacent teeth of the stator, each of which is formed between two neighboring slots, are provided with concentrated coils. These coils each pertain to a common strand and produce a magnetic flux in different directions.

The entire stator may comprise one basic form or several of such basic forms of a strand in parallel.

The stator may comprise one or more of such strand sequences in parallel; preferably, all strands have the same construction.

The stator sheet metal package of the entire stator may be manufactured from one piece or in segments.

The ratio of the number of the slots to the number of the poles in the rotor may be 12:10, for instance. Alternatively, the ratio may be 12:14, for instance. Alternatively, integer multiples of the number of the slots and of the number of the poles may be provided in each case with the above-mentioned ratios.

The stator preferably comprises a three-phase winding. Thus, the electrical machine configured in this way may be connected to an electrical three-phase system. As an alternative, 2, 4, 5 or more phases or strands are possible, too.

Alternatively or in addition, the electrical machine may comprise one of the following types: linear machine, axial-flux type machine, radial-flux type machine, asynchronous machine, synchronous machine.

The electrical machine may be constructed as a machine with an internal rotor or as a machine with an external rotor.

The rotor of the suggested electrical machine may be one of the following types, for example: a cage rotor or multi-layer rotor in the case of the asynchronous machine, or a permanent magnet rotor in the case of the synchronous machine, a rotor with buried magnets or an electrically supplied rotor such as a full-pole type rotor, salient-pole type rotor, heteropolar rotor, homopolar rotor.

A permanent magnet machine may be designed with surface magnets or with embedded or buried magnets. The machine may be designed as a synchronous machine or asynchronous machine with a cage rotor, solid rotor or multi-layered rotor.

In one embodiment of the suggested principle, some of the slots of the stator have a greater depth than the remaining slots in the stator. This allows reducing the yoke cross-section in this region by a substantial extent, for instance by at least 10%.

It is preferred that every other slot in the stator along a main direction of the rotor is designed so as to have a greater depth.

In case of a machine with twelve slots in the stator, e.g. six of these slots, i.e. every second one, may be formed so as to be deeper. For a machine comprising an integer multiple of twelve slots, integer multiples of six of these slots, preferably distributed in a regular manner along the circumference, may be formed so as to be deepened.

In doing so, the following advantages can be achieved:

The described winding form creates a field exciter curve in which the fundamental wave does not possess the maximum amplitude. However, this means that the operating wave of the machine is a harmonic component of higher order and the fundamental wave generates losses. In case the yoke cross-section is remarkably reduced at several points as described above, the fundamental wave can propagate only in an attenuated manner and the losses caused by the fundamental wave are reduced as a result. The propagation of the operating wave will not be influenced here, or only marginally.

The slot-related transverse field of the electrical machine generates additional losses in the conductors of the windings of a slot. These losses arise in particular with high frequencies in the vicinity of the slot opening. In case some of the slots are deeper, this may be utilized in various ways:

In the deeper slots, the actual winding may be placed in the slot base. Here, the end of the slot facing away from the rotor is referred to as the slot base. The slot base may have an extensive size. The region in the vicinity of the slot openings which is crucial for the generation of losses may remain unoccupied.

In addition, said part in the slot which is void of windings may be used for cooling the machine. An air-based or liquid-based cooling system may be provided, for example. In case a liquid-based cooling system is used, the liquid-transporting cooling ducts preferably consist of a material with poor conductivity or of a non-conducting material.

If the slot base in the deeper slots remains void of any windings, cooling may take place in the slot base.

One or more of the adopted measures may be combined with each other.

In a further configuration, every other tooth of the stator is designed such that the flux course in the moving direction of the movable part of the electrical machine is impeded, i.e. in the circumferential direction in case of radial-flux type machines. This may be achieved, for example, by a differing lamination direction of the sheet metal package or by using sintered iron material. This measure of designing teeth may also be taken for the slots which in part have a greater depth.

In another embodiment, the mechanical barrier in at least one portion of the stator may be designed in such a manner that the magnetic resistance effective for the fundamental wave is increased in the moving direction. In doing so, the magnetic resistance effective for the operating wave remains virtually unaffected.

The invention will be explained in more detail below on the basis of the Figures. In this connection, identical parts or parts having the same effect are provided with identical reference numerals.

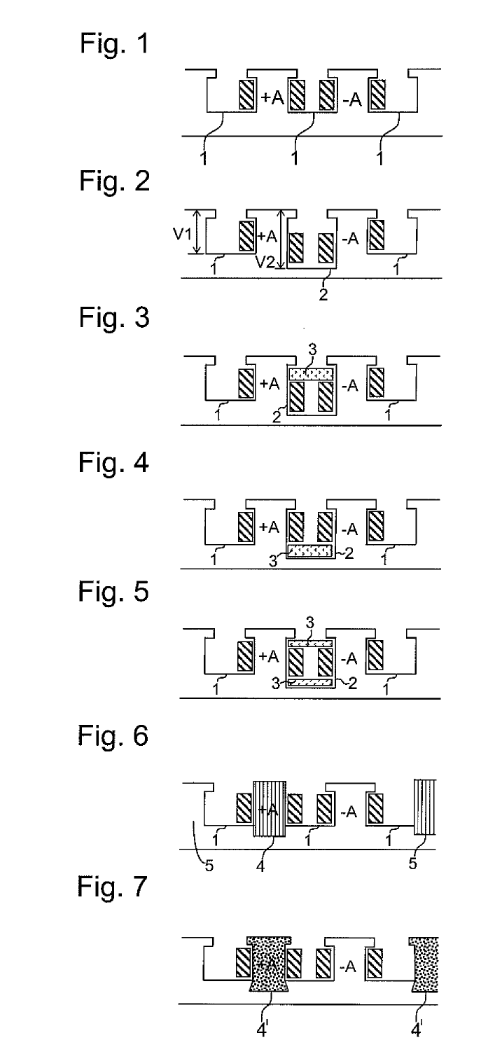

FIG. 1 shows an exemplary embodiment with concentric coils around adjacent teeth of the stator,

FIG. 2 shows a first exemplary embodiment according to the suggested principle with deepened slots,

FIG. 3 shows a further development of FIG. 2 comprising a cooling duct,

FIG. 4 shows another further development of FIG. 2 comprising a cooling duct on the basis of an example,

FIG. 5 shows an exemplary embodiment of a combination of the cooling ducts of FIGS. 3 and 4,

FIG. 6 shows an exemplary embodiment with a sheet metal package,

FIG. 7 shows an exemplary embodiment with sintered iron,

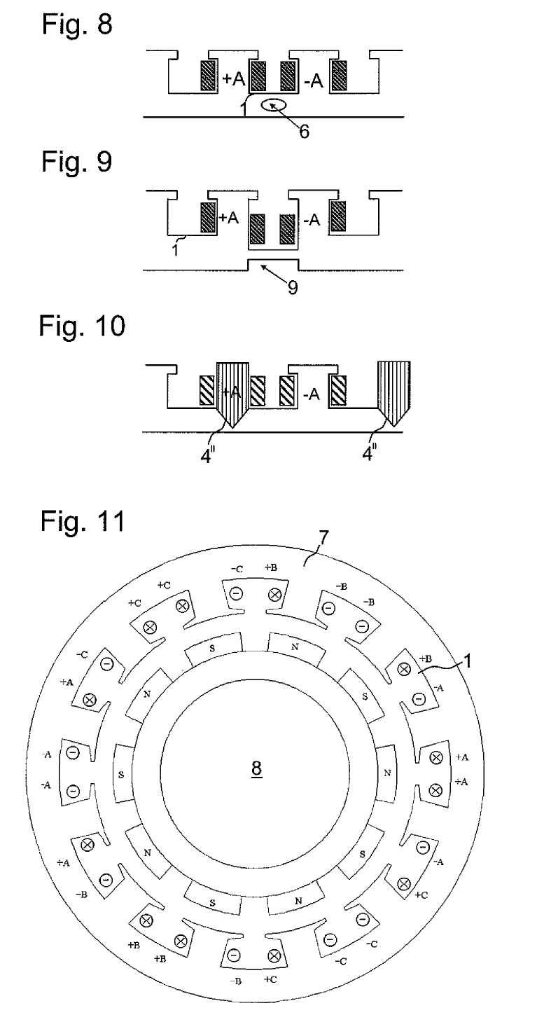

FIG. 8 shows an exemplary embodiment comprising a bore in the stator,

FIG. 9 shows an exemplary embodiment comprising an additional slot in the stator,

FIG. 10 shows a further development of FIG. 6,

FIG. 11 shows an exemplary embodiment of an electrical machine with twelve slots and ten poles,

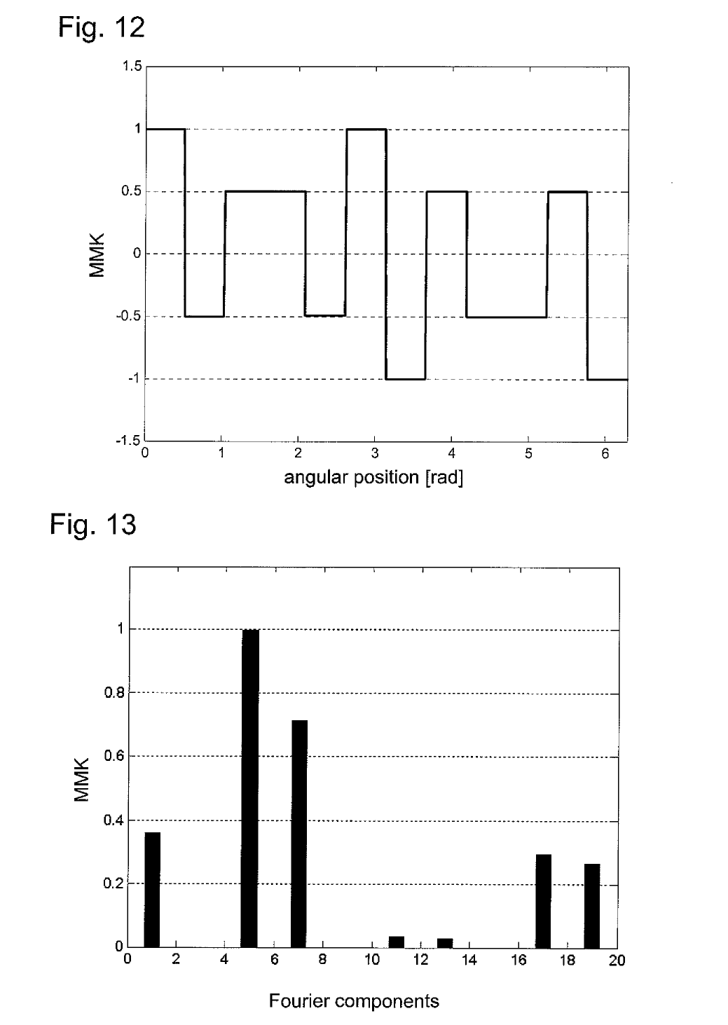

FIG. 12 shows the diagram of the magnetomotive force versus the angular position [rad] for FIG. 11,

FIG. 13 shows the diagram of the magnetomotive force by means of a decomposition into Fourier components,

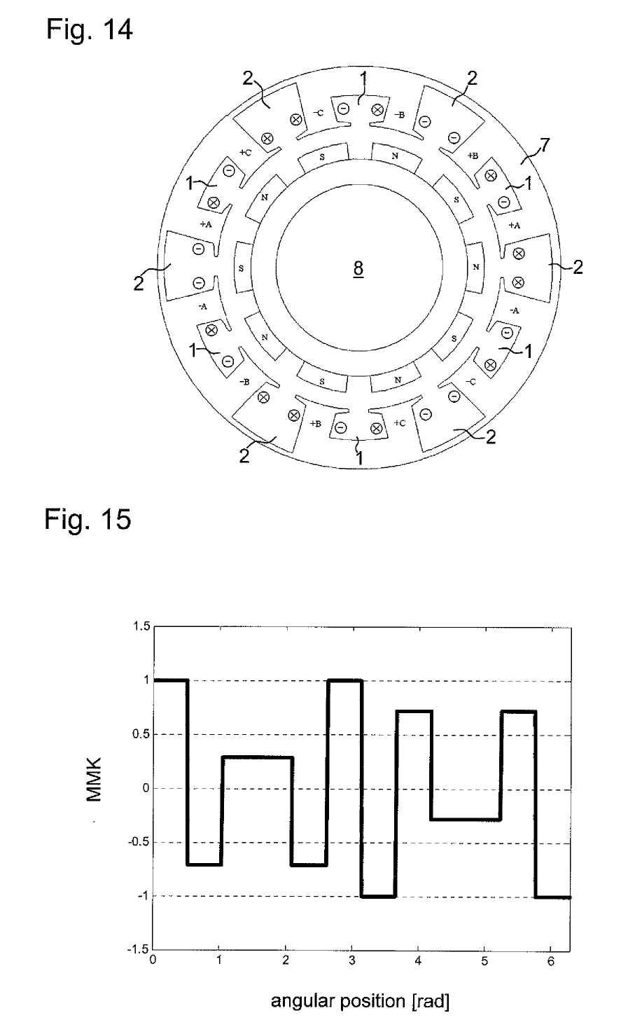

FIG. 14 shows an exemplary embodiment of an electrical machine with deepened slots according to the suggested principle,

FIG. 15 shows the diagram of the magnetomotive force versus the angular position [rad] for the design of FIG. 14,

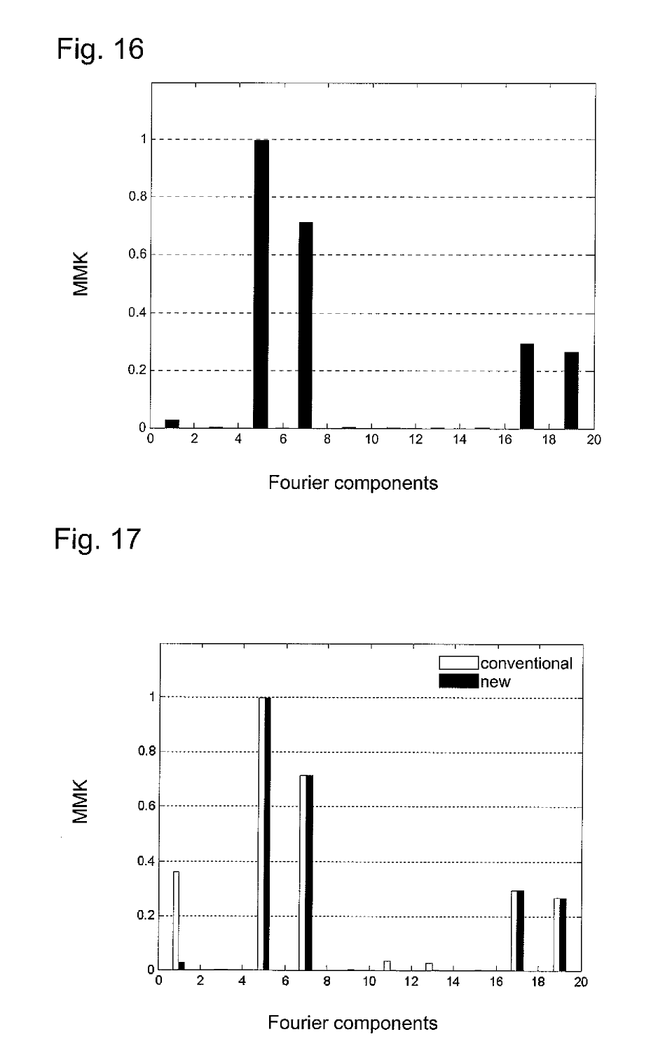

FIG. 16 shows the diagram of the magnetomotive force by means of a decomposition into Fourier components for the design of FIG. 14, and

FIG. 17 shows a comparison of the diagrams of the respective decomposition of the magnetomotive force of FIGS. 13 and 16.

FIG. 1 shows an exemplary embodiment of a section of a stator of an electrical machine. The latter is realized as a linear motor. The rotor is not shown.

It can be seen that adjacent teeth are provided with one concentrated coil each. These coils are part of a common strand A. As the two coils have different winding senses, they produce a magnetic flux in different directions. This is why these coils are referred to as +A, −A. In this example, the entire stator consists of three strands A, B, C, with the two further strands B and C being not drawn here. This results in a concentrated winding.

The entire stator may have one or more of such basic forms of a strand in parallel. This results in the winding topology +A, −A or +A, −A, +A, −A, for instance. The entire stator may comprise one or more strand sequences in parallel, i.e. +A, −A, −B, +B, +C, −C, −A, +A, +B, −B, −C, +C, for instance. It is preferred that all the strands have the same construction. In such arrangement, each strand is assigned to an electrical phase of an electrical multi-phase system to which the electrical machine may be connected.

In the example according to FIG. 1, all slots 1 have the same slot depth.

FIG. 2 shows an exemplary embodiment of a section of a stator according to the suggested principle. Based on FIG. 1, every other slot 2 is formed so as to be deeper in FIG. 2. In doing so, the slots 2 are formed with a deepening V2 which is significantly larger than the deepening V1 of the slots 1. In this respective region of the stator, the deeper slots 2 result in a yoke cross-section of the stator material remaining in the region of the slot which is reduced by 50%. Every other slot 2 is realized so as to be deeper in this example. In this example, the stator according to FIG. 2 is designed as a stator sheet metal package and may be manufactured from one piece or in segments.

The deepened slots 2 are each arranged between portions of the stator which comprise adjacent teeth provided with windings of the same strand. Any slots 1 between portions of the stator comprising neighboring teeth which are provided with windings of different strands have a conventional depth V1 as compared thereto.

The reduction of the yoke cross-section at several points, namely in the region of the deepened slots 2, results in an attenuated propagation of the fundamental wave. This reduces the losses due to the fundamental wave. The propagation of the operating wave, however, for instance of the fifth or seventh harmonic component of the Fourier decomposition of the magnetomotive force, remains virtually unaffected.

In addition, the winding is placed in the slot base for the deeper slots 2 in the example according to FIG. 2. This results in the additional advantage that the region in the vicinity of the slot openings which is more crucial in terms of formation of losses may remain unoccupied. Such losses appear in particular at high frequencies.

FIG. 3 shows a further development of the stator section of FIG. 2. The design according to FIG. 3 largely corresponds to that of FIG. 2. In addition to FIG. 2, however, a cooling duct 3 is introduced in the region of the slot opening for the deeper slots 2. The cooling duct may be used for an air-based or liquid-based cooling system.

FIG. 4 shows another further development of FIG. 2. Unlike FIG. 2, the winding in the deeper slots 2 is not placed in the slot base in the design according to FIG. 4. Rather, the winding is arranged like in FIG. 1. Through this measure, the slot base of the deeper slots remains void of any winding. This additionally gained space in the slot base of the deeper slots 2 may be used for providing cooling ducts 3 in the slot base.

In an exemplary embodiment, FIG. 5 shows a combination of cooling ducts in the region of the slot opening and in the region of the slot base for the deeper slots 2. Thus, FIG. 5 combines the designs of the cooling ducts according to FIGS. 3 and 4 in the region of the slot opening and in the region of the slot base for the deeper slots. The winding in the deeper slots 2 is neither unchanged in the region of the slot opening nor completely displaced in the slot base, but is positioned in the middle between both positions.

FIG. 6 shows another embodiment of a mechanical barrier for the fundamental wave in at least one portion of the stator. Instead of deepened slots 2 as illustrated in FIGS. 2 to 5, FIG. 6 shows an implementation where every other tooth 4 is not formed with the conventional stator material, but comprises a sheet metal package. The sheet metal package extends beyond the slot base of the slots 1 which are formed with the conventional depth and extends into the region of the yoke. Compared to the remaining stator region which in many cases is realized as a stator sheet metal package, the laminating direction has another orientation in the region of the teeth 4. In the present example, the laminating direction in the region of the teeth 4 has a surface normal in the moving direction of the rotor. The teeth 5 located between the teeth 4 modified in such a way are unchanged.

FIG. 7 shows an alternative to the design of FIG. 6. The modified teeth 4 carrying reference numeral 4′ in FIG. 7 are not realized with a stator sheet metal package of a differing preferential direction, but differ from the remaining stator by the material which has been selected. In the region of the teeth 4′, a sintered iron material is used. The teeth 4′, i.e. every other tooth in the exemplary embodiment according to FIG. 7, comprise this sintered iron material. The remaining teeth 5 are unchanged like in FIG. 6. In embodiments which are not shown, the measures for the teeth according to FIGS. 6 and 7 may also be combined with the deepened slots 2, as exemplarily shown on the basis of FIGS. 2 to 5.

FIG. 8 shows an alternative embodiment to the design according to FIG. 2.

Instead of deepened slots 2, as shown exemplarily in FIGS. 2 to 5, a mechanical barrier for the fundamental wave of the magnetic flux in a portion of the stator is realized by a bore 6 in the design of FIG. 8. Here, the bore extends in the yoke region which is provided with a deepened slot in FIG. 2. When designed as a rotating machine, the bore extends in axial direction. In general, the bore is parallel to the slot base of the slots 1, 2.

An elliptic or angular cross-section may be provided instead of a bore with a round cross-section in alternative designs. It goes without saying that other cross-sections are also possible in the context of the suggested principle, for instance triangular cross-sections.

FIG. 9 shows a further alternative to the design of FIG. 2. Instead of deepened slots 2 as exemplarily shown by means of FIGS. 2 to 5, the design of FIG. 9 is provided with an additional slot 9 on the side of the stator facing away from the rotor. The slot 9 is arranged in the yoke region comprising a deepened slot in FIG. 2. In the design of FIG. 9, the additional slot 9 is aligned with the slot 1 provided in this region on the side of the rotor.

FIG. 10 shows a further development of the mechanical barrier according to FIG. 6. In FIG. 10, every other tooth 4″ is designed such that the tooth comprises a stator sheet metal package. The individual sheet metals, however, differ in length. In the region of the yoke, there is no rectangular cross-section, but the stator when seen in top view shows an arrow-shaped taper pointing towards the side of the stator facing away from the rotor. This results in an additional barrier effect for the fundamental wave in the region of the yoke of those teeth 4″ whose sheet metal package has another preferential direction compared with the stator sheet metal package. The stator flux with respect to the fundamental wave is thereby reduced further.

FIG. 11 shows an exemplary embodiment of a rotating electrical machine comprising a stator 7 and a rotor 8. The stator comprises twelve slots 1. The windings +A, −A, +B, −B, +C, −C of a three-phase winding are wound around each tooth of the stator as concentrated windings. The rotor 8 has ten poles which are realized with permanent magnets applied to the rotor. Five north poles and five south poles N and S, respectively, are arranged so as to alternate with each other.

Exemplary graphs of FIGS. 12 and 13 show the magnetomotive force plotted versus the angular position in rad (FIG. 12) and versus the Fourier components with a corresponding decomposition (FIG. 13). It can be seen that in such a machine it is in particular the fundamental wave which is significant here, i.e. the Fourier component of the first harmonic order, representing a subharmonic component with respect to the operating wave, namely of the fifth harmonic component.

FIG. 14 shows an exemplary embodiment of a rotating electrical machine according to the suggested principle in which the fundamental wave described on the basis of FIG. 13 is significantly reduced. To this end, the design according to FIG. 14 has every other slot realized with a greater depth. The deeper slots are provided with reference numeral 2, whereas the slots of conventional and hence shallower depth as in FIG. 11 are provided with reference numeral 1. The winding topology of FIG. 14 is the same as in FIG. 11.

It can be seen in FIG. 14 that a total number of six slots 2 among the twelve slots 1, 2 are formed so as to be deeper. The yoke cross-section is reduced to a value of less than 50% compared to the yoke cross-section for the conventional slots 1.

In the case of a machine with a total of twelve slots and ten poles, a mechanical barrier for the fundamental wave is formed at six portions of the stator which are regularly distributed along the circumference of the stator. Here, the mechanical barrier is formed by the reduced yoke cross-section between the deepened slot 2 and the corresponding side of the stator facing away from the rotor. This results in a situation where the propagation of the fundamental wave is effectively and significantly reduced, whereas the operating wave, i.e. the fifth harmonic component in this case, remains virtually unchanged.

The magnetic resistance effective for the fundamental wave is increased in the yoke region of the deepened slots in the moving direction. The magnetic resistance effective for the operating wave remains virtually unaffected.

In this arrangement, the deeper slots are provided with a different winding sense between windings in the same strand, but not between different strands of the electrical winding. Exactly there, the depth of the slot with respect to FIG. 11 is unchanged. This arrangement of the deepened slots has an impact on the fundamental wave, but virtually not on the operating wave.

It is to be noted here that the yoke in the region of the deeper slots 2 is not effectively interrupted in terms of the magnetic conditions, but is merely weakened. An effective interruption would also weaken the travel motion of the useful fields. In the design of FIG. 14, for instance, the fundamental wave is weakened by 90%; the operating wave, however, is weakened by a value of only less than 5%. These figures apply with the rated moment of the electrical machine in operation.

FIGS. 15 to 17 illustrate the advantages of the design of FIG. 14 on the basis of the respective diagrams of the magnetomotive force plotted versus the angular position according to FIG. 15, versus the Fourier components of FIG. 16 as well as by means of a comparison of the graphs of FIG. 13 and FIG. 16.

### LIST OF REFERENCE NUMERALS

1 slot
2 deepened slot
3 cooling duct
4 sheet metal package
4′ sintered iron
4″ sheet metal package
5 tooth
6 bore
7 stator
8 rotor
9 additional slot
A winding
B winding
C winding
+ winding sense, positive
− winding sense, negative

1.-17. (canceled)

18. An electrical machine comprising:
a stator including slots for receiving electrical windings; and
a rotor which is adapted to be moved relative to the stator,
wherein when in operation, an operating wave of the magnetomotive force differs from a fundamental wave of the magnetic flux, and
wherein a mechanical barrier for the fundamental wave of the magnetic flux is provided in at least one portion of the stator, the mechanical barrier being designed such that the fundamental wave is weakened while the operating wave remains essentially unaffected, and wherein the mechanical barrier is designed as a geometric reduction of the yoke cross-section of the stator and/or as an effective reduction of the yoke cross-section for the flux course in the circumferential direction.

19. The electrical machine according to claim 18, wherein the mechanical barrier comprises a slot in the stator, which slot is arranged between two regions of the stator which are provided with coils of a common strand of a stator winding of the electrical machine, by means of deepening the slot to a depth V2, whereas a slot between regions of the stator which are provided with coils of different strands, has a smaller, conventional depth V1 compared thereto.

20. The electrical machine according to claim 18, wherein the mechanical barrier is designed such that the fundamental wave in the at least one portion of the stator is weakened by 50% or more.

21. The electrical machine according to claim 18, wherein the mechanical barrier is designed such that, at rated torque, the fundamental wave in the at least one portion of the stator is weakened by at least 90%, the operating wave in this region being weakened by less than 10%.

22. The electrical machine according to claim 19, wherein the slot is provided on a side of the stator facing the rotor.

23. The electrical machine according to claim 19, wherein the slot is provided on a side of the stator facing away from the rotor.

24. The electrical machine according to claim 22, wherein a cooling duct is incorporated in the slot.

25. The electrical machine according to claim 18, wherein the mechanical barrier comprises a bore in the stator.

26. The electrical machine according to claim 18, wherein the mechanical barrier comprises a sheet metal package exhibiting a preferential direction which is different from that of a sheet metal package of the stator.

27. The electrical machine according claim 18, wherein the mechanical barrier in the at least one portion of the stator comprises a material which is different from the material of the stator outside this at least one portion.

28. The electrical machine according to claim 18, wherein the mechanical barrier comprises sintered iron or SMC, Soft Magnetic Composites.

29. The electrical machine according to claim 18, wherein the ratio of the number of the slots to the number of the poles in the rotor is 12/10 or 12/14, or is defined in each case by integer multiples of the number of the slots and of the number of the poles.

30. The electrical machine according to claim 18, wherein the electrical machine comprises one of the following types: linear machine, axial-flux type machine, radial-flux type machine, asynchronous machine, synchronous machine.

31. The electrical machine according to claim 18, constructed as a machine with an internal rotor or as a machine with an external rotor.

32. The electrical machine according to claim 18, wherein the rotor is one of the following types: a cage rotor or multi-layer rotor in the case of the asynchronous machine, or a permanent magnet rotor in the case of the synchronous machine, a rotor with buried magnets or an electrically supplied rotor, in particular full-pole type rotor, salient-pole type rotor, heteropolar rotor, homopolar rotor.
